(19) United States
(12) Patent Application Publication
(10) Pub. No.: US 2011/0317170 A1
(43) Pub. Date: Dec. 29, 2011

(54) WEDGE PAIR FOR PHASE SHIFTING

(76) Inventors: Yung-Chieh Hsieh, San Jose, CA (US); Chiayu Ai, Newark, CA (US)

(21) Appl. No.: 13/150,404

(22) Filed: Jun. 1, 2011

Related U.S. Application Data
(63) Continuation-in-part of application No. 11/360,959, filed on Feb. 22, 2006.
(60) Provisional application No. 61/350,109, filed on Jun. 1, 2010.

(51) Int. Cl. G01B 9/02; G02B 26/06

(52) U.S. Cl. 356/520; 359/290

(57) ABSTRACT

The invention provides a wedge pair suitable for use in interferometers. The wedge pair produces a phase shift between beams of light propagating in the interferometer. The invention includes a wedge pair and a mechanism for translating a first wedge of the pair with respect to a second wedge of the pair, where the first wedge has the same wedge angle and material of the second wedge and where the vertex of the first wedge and the vertex of the second wedge are pointed in opposite directions.

### CROSS-REFERENCE TO RELATED APPLICATIONS

This is a continuation-in-part of U.S. patent application Ser. No. 11/360,959, titled “Interferometer Based Delay Line Interferometers,” filed Feb. 22, 2006, incorporated herein by reference. This application claims the benefit of U.S. Provisional Patent Application No. 61/350,109, titled “Wedge Pair For Phase Shifting,” filed Jun. 1, 2010, incorporated herein by reference.

### BACKGROUND OF THE INVENTION

1. Field of the Invention

The present invention relates to phase shifting interferometers, and more specifically, it relates to means for producing a phase shift between two beams propagating in such interferometers.

2. Description of Related Art

The stability of both arms of an interferometer is important. The movement of either arm can affect the optical path difference between those two arms. Low thermal expansion spacer material (such as Zerodur, ULE or fused silica) has been used to hold the mirror in each arm thermally and mechanically stable. FIG. 1 shows a prior art Michelson interferometer that uses spacers made of low coefficient of thermal expansion (CTE) material to maintain the distances between the mirrors and the beamsplitter. In the figure, mirror 10 and mirror 12 are offset from beamsplitting cube 14 by low CTE spacers 16.

Sometimes, it is desirable to shift the transmission peaks propagating in an interferometer. This can be done by adjusting the optical path length in one arm. For example, a tuning window can be inserted in one arm, e.g., as described in U.S. Pat. No. 6,816,315, incorporated herein by reference, or by using a temperature sensitive element as a phase modulating element, e.g., as described in U.S. Pat. No. 7,522,343, incorporated herein by reference.

Because the element is inserted inside the cavity, the stability of both arm is preserved. However, the tuning speed obtained using the above mentioned means is slow, generally within a range from 10 ms to 100 ms. A fast tuning means is needed, such as less than 1 ms.

A phase shifting interferometer (based, e.g., on a Michelson or a Mach Zehnder design) has used a piezo-electric transducer (PZT) to move one of the mirrors in order to provide the needed phase shift. See, e.g., U.S. Pat. No. 4,639,139, incorporated herein by reference. For instance, in FIG. 2, one mirror is attached to a piezo actuator, which in turn is attached to a fixture. The moving mirror cannot be affixed to the beam splitter with a spacer as shown in the other arm. Otherwise, this mirror cannot move. Therefore, the movable mirror is subject to the stability of the PZT and the fixture. FIG. 2 shows a Michelson interferometer with a PZT to drive a mirror to control the distance between that and the beamsplitter. In the figure, mirror 20 is attached to beamsplitter cube 22 with low CTE spacers 24. Mirror 26 is not attached to the beamsplitter cube 22 but is attached to a piezo-electric transducer 28 which is attached to a fixture 30.

### SUMMARY OF THE INVENTION

Embodiments of the invention comprise a wedge pair suitable for us in interferometers. The wedge pair provides a phase shift between beams of light propagating in the interferometer. The invention includes a wedge pair and means for translating a first wedge of the pair with respect to a second wedge of the pair, where the first wedge comprises the same wedge angle and material of the second wedge and where the vertex of the first wedge and the vertex of the second wedge are pointed in opposite directions. The first wedge and the second wedge are configured in a combination that is about equivalent to a plane parallel plate. The pair of wedges are configured in a combination where the total optical thickness remains the same when both wedges move together. One of the wedges is attached to a piezo-electric transducer (PZT) which is attached to a first support structure. The second wedge is attached to a second support structure which may be attached to the first support structure. In some embodiments, the CTE of the second support structure is about the same as the CTE of the PZT. In some embodiments, the first wedge and the second wedge both comprise material of low optical thermal coefficient. Some embodiments include means for adjusting the temp of at least one of the PZT or the second support structure.

The wedge pair can be located in a first arm of the interferometer. Exemplary interferometers used in the present invention include a Michelson interferometer and a Mach Zhender interferometer. An optic can be located in a second arm of the interferometer, where the optic comprises the same optical path length as the sum of the optical path length of the first wedge with the optical path length of the second wedge. The interferometer can be a phase shifting interferometer. Other embodiments include a wedge pair and means for translating a first wedge of the pair with respect to a second wedge of the pair, where the first wedge and the second wedge comprise different dimensions and/or material but one compensates for the other by comprising a compensating dimension and/or material and where the vertex of the first wedge and the vertex of the second wedge are pointed in opposite directions.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 shows a prior art Michelson interferometer, with low CTE spacers to hold the distance between the mirror and the beam splitter.

FIG. 2 shows a Michelson interferometer with a PZT to drive a mirror to control the distance between that mirror and the beamsplitter.

FIG. 3 shows a wedge pair with one wedge of the pair mounted on a PZT to move the wedge along the Y direction, while the other wedge is affixed to a base.

FIG. 4 shows an embodiment PZT driven phase-shifting interferometer according to the present invention.

FIG. 5 shows a Mach Zehnder interferometer with a wedge pair located in one of its optical paths.

### DETAILED DESCRIPTION OF THE INVENTION

An optically transmissive wedge pair usually comprises two equal-angle wedges, usually composed of the same material. They are arranged so that their vertices are pointed in opposite directions. The combination of the pair is equivalent to a plane parallel plate. If both wedges move together, the total optical thickness remains the same.

Due to the structure, vibration can cause the wedge to move much more in the two directions perpendicular to y-axis. Because the wedges are used in transmission, only the movement of a wedge along the y-axis can affect the optical thickness. When a voltage is applied to a PZT that is connected to a wedge, the wedge moves along the length direction (y-direction), and hence changes the total optical thickness of the pair. Therefore, a wedge pair can effectively provide the needed phase shift without sacrificing the stability, by moving one wedge while holding the other wedge still.

A piezo-electric actuator can easily induce a displacement of a few microns, e.g., at an operation voltage as low as 80 V, with a frequency of, e.g., a few KHz. At zero-incidence angle, the optical thickness change, ΔT, caused by the displacement, P, in the y-direction of a piezo actuator can be expressed as

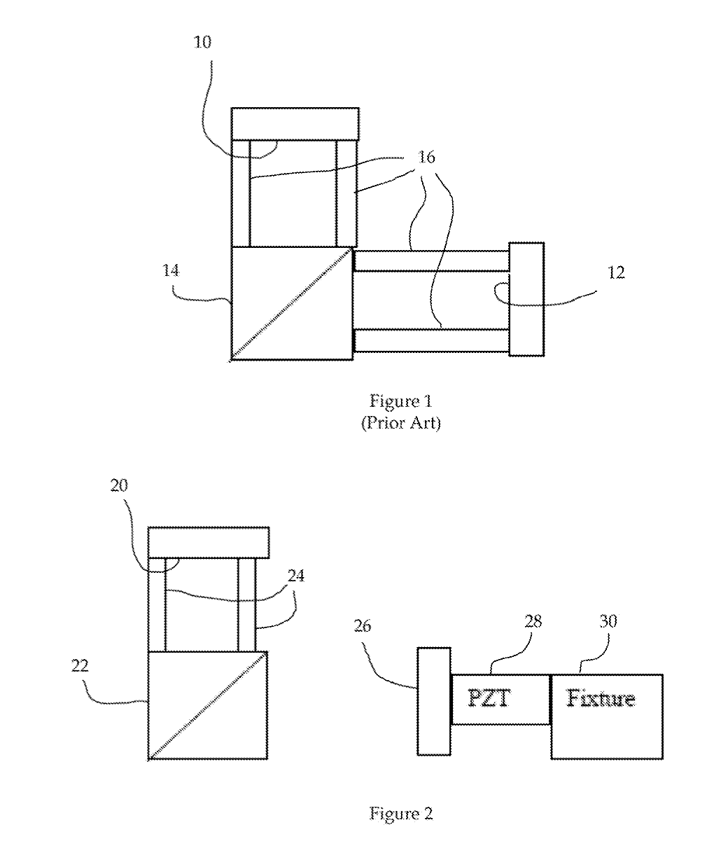

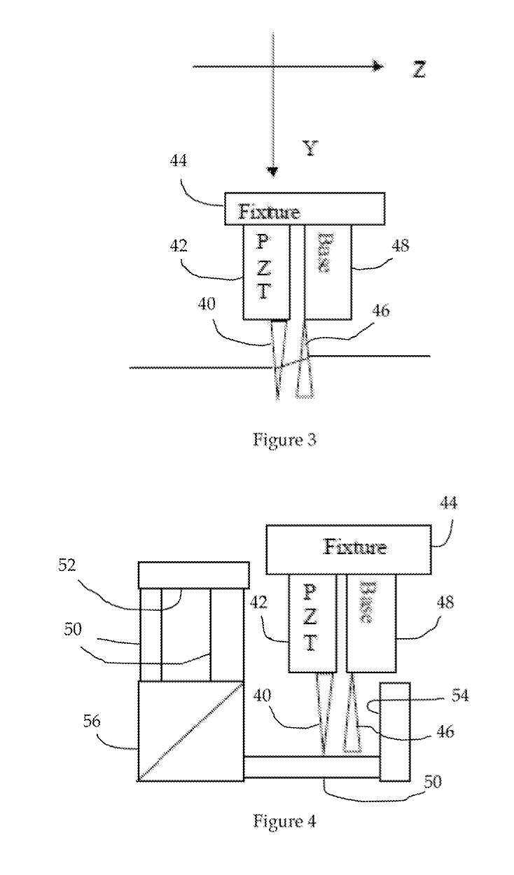

ΔT=tan(β)×P×(n−1),

where n is the refractive index of the wedge, and β is the wedge angle. For instance, for a wedge with β=1.7 degrees and n=1.9, a displacement of P=1 μm can induce an optical thickness change ΔT=0.277 μm. As a result, any unwanted movement of either wedge in the y-axis is reduced by 72%. Therefore, the use of wedge pair shown in FIG. 3 is less subject to vibration than the means in FIG. 2.

For a beam transmitted through a wedge or prism, when the incidence angle is equal to the transmitted angle, the beam has a minimum deviation. At this incidence angle, the transmitted beam angle remains almost unchanged when the wedge is tilted about an axis parallel to its vertex (x-axis). Again, this shows that the use of the wedge pair shown in FIG. 3 provides a much more stable means for phase shift than that shown FIG. 2. In the figure, a wedge 40 is attached to PZT 42 which is attached to fixture 44. Fixture 44 is sometimes referred to herein as a first support structure. Wedge 46 is attached to a base 48 which is attached to the fixture 44. Base 48 is sometimes referred to herein as a second support structure.

If both wedges are mounted on a the same fixture, then both wedges will move together. Thus, it is not necessary for the CTE of the fixture to be near zero. As shown in FIG. 3, the two wedges are mounted differently; one is mounted to the support with a PZT and the other is mounted to the support with a base. Because the thermal expansion coefficient (CTE) of a PZT is not as small as that of Zerodur, the thermal expansion of the PZT should be compensated for by the base in FIG. 3, in order to have a good thermal stability.

In addition to the CTE of each of the PZT and the base, the refractive index of the wedge could be a function of the temperature. The optical thermal coefficient, g, of the wedge is

g=dn/dT+(n−1)α,

where n is the refractive index, dn/dT is the slope of the refractive index versus the temperature, and α is the CTE of the wedge. Therefore, the total optical thickness of the wedge pair is also a function of temperature. The change of the total optical thickness, ΔTₜ, due to the temperature change, can be expressed as

ΔTₜ=g×L×Temperature difference,

where L is the total mechanical thickness of the wedge pairs along the beam path. For instance, for L=4 mm, g=4.3 ppm, and temperature difference=45 degree C., we obtain ΔTₜ=0.775 μM. This can be compensated for by inserting the same material with the same mechanical thickness as the wedge, into the other optical path of the interferometer. Or using a different material g′, and thickness L′ so that

g′×L′=g×L.

By combining the two prior arts with this wedge pair, one can obtain a phase-shifting interferometer with very fast response and high thermal and mechanical stability. FIG. 4 shows a PZT driven phase-shifting interferometer according to the present invention. In the figure, low CTE spacers 50 are used to attach mirrors 52 and 54 to beamsplitter 56. The device illustrated in FIG. 3 is inserted into one arm of the interferometer. A wedge 40 is attached to PZT 42 which is attached to fixture 44. Wedge 46 is attached to a base 48 which is attached to the fixture 44.

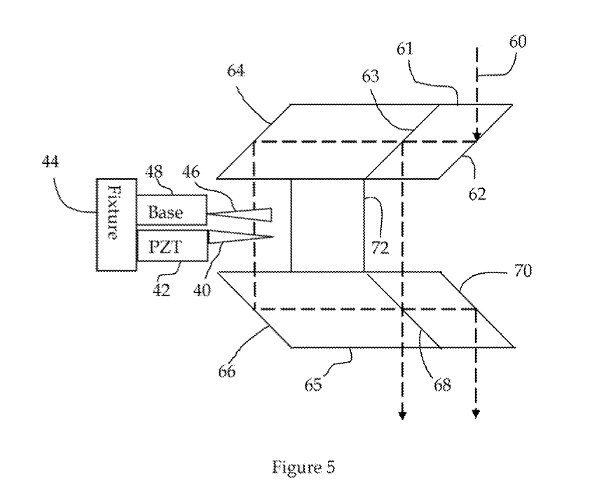

The PZT can be used in at least one of the two arms of the Michelson interferometer. It can also be applied to Mach-Zehnder interferometer. Such kind of interferometer can be used for a DPSK and a DQPSK demodulator for telecommunication applications and for other fast tuning phase-shifting interferometers. FIG. 5 shows a Mach Zehnder interferometer with a wedge pair located in one of its optical paths. A beam 60 enter optical element 61 and is reflected from mirror 62 and is directed through beamsplitter 62 after which is its reflected from mirror 64, then passing through wedge pair 46, 40, and after which is enter element 65 wherein it reflected from mirror 66 to be split at beamsplitter 68 and one of the split beams is reflected from mirror 70. The two split beams from beamsplitter 63 are recombined in the two output beams from beamsplitter 68.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. An apparatus, comprising:
a wedge pair; and
means for translating a first wedge of said pair with respect to a second wedge of said pair, wherein said first wedge comprises the same wedge angle and material of said second wedge and wherein the vertex of said first wedge and the vertex of said second wedge are pointed in opposite directions.

2. The apparatus of claim 1, wherein said first wedge and said second wedge are configured in a combination that is about equivalent to a plane parallel plate.

3. The apparatus of claim 1, wherein said first wedge and said second wedge are configured in a combination wherein the total optical thickness remains the same when both wedges move together.

4. The apparatus of claim 1, wherein said first wedge is attached to a piezo-electric transducer (PZT).

5. The apparatus of claim 4, wherein said PZT is attached to a first support structure.

6. The apparatus of claim 5, wherein said second wedge is attached to a second support structure.

7. The apparatus of claim 6, wherein said second support structure is attached to said first support structure.

8. The apparatus of claim 7, wherein the CTE of said second support structure is about the same as the CTE of said PZT.

9. The apparatus of claim 1, wherein said first wedge and said second wedge both comprise material of low optical thermal coefficient.

10. The apparatus of claim 7, further comprising means for adjusting the temp of at least one of said PZT or said second support structure.

11. The apparatus of claim 1, further comprising an interferometer, wherein said wedge pair is located in a first arm of said interferometer.

12. The apparatus of claim 11, wherein said interferometer is selected from the group consisting of a Michelson interferometer and a Mach Zhender interferometer.

13. The apparatus of claim 11, wherein said interferometer comprises a phase shifting interferometer.

14. The apparatus of claim 11, wherein said interferometer comprises a first mirror, a second mirror and a beamsplitter, wherein said beamsplitter is positioned to separate an input beam into a first beam and a second beam, wherein said first beam will reflect from said first mirror back to said beamsplitter, wherein said second beam will reflect from said second mirror back to said beamsplitter, wherein both said mirrors are attached to said beamsplitter.

15. The apparatus of claim 14, wherein at least one of said first mirror or said second mirror are attached to a piezo-electric transducer.

16. The apparatus of claim 14, wherein said second beam will reflect from said second mirror back to said beamsplitter, wherein at least one of said first mirror and said second mirror are attached to said beamsplitter.

17. The apparatus of claim 14, wherein at least one of said first mirror and said second mirror are attached to said beamsplitter with a spacer comprising low CTE material.

18. The apparatus of claim 14, wherein at least one of said first mirror and said second mirror are attached to said beamsplitter with a spacer comprising thermally sensitive material.

19. An apparatus, comprising:
a wedge pair;
means for translating a first wedge of said pair with respect to a second wedge of said pair; and
an optic located in a second arm of said interferometer, wherein said optic comprises the same optical path length as the sum of the optical path lengths of said first wedge and said second wedge.

20. An apparatus, comprising:
a wedge pair; and
means for translating a first wedge of said pair with respect to a second wedge of said pair, wherein said first wedge and said second wedge comprise different dimensions and/or material but one compensates for the other by comprising a compensating dimension and/or material and wherein the vertex of said first wedge and the vertex of said second wedge are pointed in opposite directions.
